(19) United States
(12) Patent Application Publication
(10) Pub. No.: US 2008/0250083 A1
(43) Pub. Date: Oct. 9, 2008

(54) METHOD AND SYSTEM OF PROVIDING A BACKUP CONFIGURATION PROGRAM

(75) Inventors: Nicholas R. Kovacs, Tucson, AZ (US); William Scheid, Tucson, AZ (US); Deanna M. Shaw, Gilroy, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/695,987

(22) Filed: Apr. 3, 2007

(51) Int. Cl. G06F 17/00

(52) U.S. Cl. 707/204; 707/E17.005

(57) ABSTRACT

Methods and a system are provided for generating a list of user selectable files for backup based upon program properties. The file space on a user's computer or a computer network is searched for application programs, data files and file extension types stored therein. Once these items are located, they are correlated together in a registry. The correlated items are then sorted and ranked in a list for backup based on a sealing factor. The sorted and ranked list is presented to the user in a graphical user interface. The user is then able to easily select the files, applications, or directories that have the highest usage for backup. The user-selected list of files for backup is supplied to backup application program. The user-selected files and other iteration information are stored in a memory for future reference.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention relates generally to configuring backup application programs and in particular to selecting files for backup in a backup application program.

2. Description of Background

Backup software application programs that are designed to back up computer files often rely on end users to understand file name extensions and related application programs in order to designate specific files for backup. Therefore, it is difficult for computer users to determine which files to include or exclude for a backup session. Software in this domain requires that a user have extensive knowledge of applications, their associated filename extensions and the operating system being used. This makes configuration of a backup product difficult for a user who is unfamiliar with all the applications, filenames extensions and directories found in a typical computer system. The current art is lacking a simplified user interface for assisting a user in determining which files on his or her computer should be included in a back up session.

The current approach places a heavy burden on the user to determine which files to backup. Furthermore, the current state of the art of backup software relies heavily on the user's knowledge of file extensions. However, market research indicates that most consumer users do not know the extension of every application they use. Some software applications provide guides to assist with user selection of files to backup. However, most of these systems are inadequate.

The current state of the art in backup software provides a very complex system to explain what to protect during backup. Current solutions either present a guess of what applications might be a user's system, or worse, they offer a vague list of extensions that could lead to an undesirable level of protection. Often, the user will include everything stored in the system for backup, which can be inefficient. However, the user might also miss some files that should be backed up. These solutions require extensive knowledge of the applications in order to choose the right extensions to manage. This knowledge is something that most in the corporate and consumer user communities do not possess. At best, users in these communities may only know a few file extensions.

### SUMMARY

According to an exemplary embodiment, a method is provided for generating a list of recommended files for backup. The method comprises pre-selecting for backup certain application programs, data files and file extension types stored in a computer file space. The method also comprises searching the file space to discover other application programs, data files and file extension types stored therein. An application hash-map is created containing application programs found within the file space and their associated file extension types. Data files having certain file extension types are correlated to its associated application program based on information stored in the application hash-map. A selectable list of items for backup is generated, wherein the items include application programs, data files and file extension types, and wherein items on the list are ranked based on a scaling factor. The list of items for backup is presented to a user in a graphical user interface.

According to another embodiment, a system is provided for generating a list of recommended files for backup. The system comprises a computer file space containing pre-selected application programs, data files and file extension types for backup. The computer file space is searched to discover other application programs, data files and file extension types stored therein. An application hash-map is created containing application programs found within the computer file space and their associated file extension types. The application hash-map is used to correlate data files having certain file extension types to its associated application program. A selectable list of items for backup is generated, wherein the items include application programs, data files and file extension types, and wherein items on the list are ranked based on a scaling factor. Finally, a graphical user interface is used to present the end user with a selectable list of items for backup.

Still further in another exemplary embodiment, a method is provided for generating a list of recommended files for backup. The method comprises configuring an application program to automatically search a network file space on a computer network for at least one of directories, application programs, data files and file extension types that are pre-selected for backup. The method includes monitoring computer usage to record usage information including at least one of accessed directories, accessed application programs, accessed data files and accessed file extension types. Patterns of use are identified based on the usage information and compiling usage data. The usage data is processed within a pattern recognition process to determine at least one of directories, application programs, data files and application file extension types, having priority for backup based on a scaling factor and listing the data in a ranked list of recommended items for backup. The network file space is searched to determine other directories, application programs, data files and file extension types stored therein. An application hash-map is created containing application programs found within the network file space and their associated file extension types. Data files having certain file extension types are correlated to its associated application program based on the information stored in the application hash-map. A correlated list of items for backup is created, wherein the items include at least one of directories, application programs, data files and application file extension types that are ranked according to a scaling factor. Next, a selectable list of ranked items for backup based on both the ranked list of recommended items for backup and the list of correlated items for backup is created. The selectable list of items for backup is presented to the user for selection.

System and computer program products corresponding to the above-summarized methods and systems are also described herein.

Additional features and advantages are realized through the techniques of the exemplary embodiments. Other embodiments and aspects of the invention are described in detail herein and are considered a part of the exemplary embodiments. For a better understanding of the embodiments with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention are apparent from the following detailed description taken in conjunction with the accompanying drawings in which:

FIG. 1 is a block diagram of computing system architecture according to an exemplary embodiment.

FIG. 2 is a flowchart of an exemplary embodiment of a backup configuration process.

FIG. 3 is a flowchart of a further exemplary embodiment of a backup configuration process.

The detailed description explains exemplary embodiments, together with advantages and features, by way of example with reference to the drawings.

### DETAILED DESCRIPTION

According to an exemplary embodiment, the process of selecting what to protect during a backup is simplified. The technique described herein provides information in a manner that corporate and consumer communities understand. In addition, it protects files that typically would not get protected, like the configuration setting of a product.

The capabilities of the exemplary embodiments described herein can be implemented in software, firmware, hardware or some combination thereof. Although described with particular reference to an application backup system in the Windows operating system, published by the Microsoft Corporation of Redmond, Wash., the exemplary embodiments described herein can be implemented in any information technology (IT) system in which the backup of program and data files is desirable. Further, the exemplary embodiments are not restricted to data storage architectures that employ directories and files. For example, proposed operating systems include database structures rather than files and directories. The disclosed technology is equally applicable in virus software exclusion list and firewall application access lists. Those with skill in the computing arts will recognize that the disclosed embodiments have relevance to a wide variety of computing environments in addition to those described below. In addition, the methods of the disclosed embodiments can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “file space,” a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory) and a portable compact disk read-only memory or another suitable medium upon which a program and/or data may be stored.

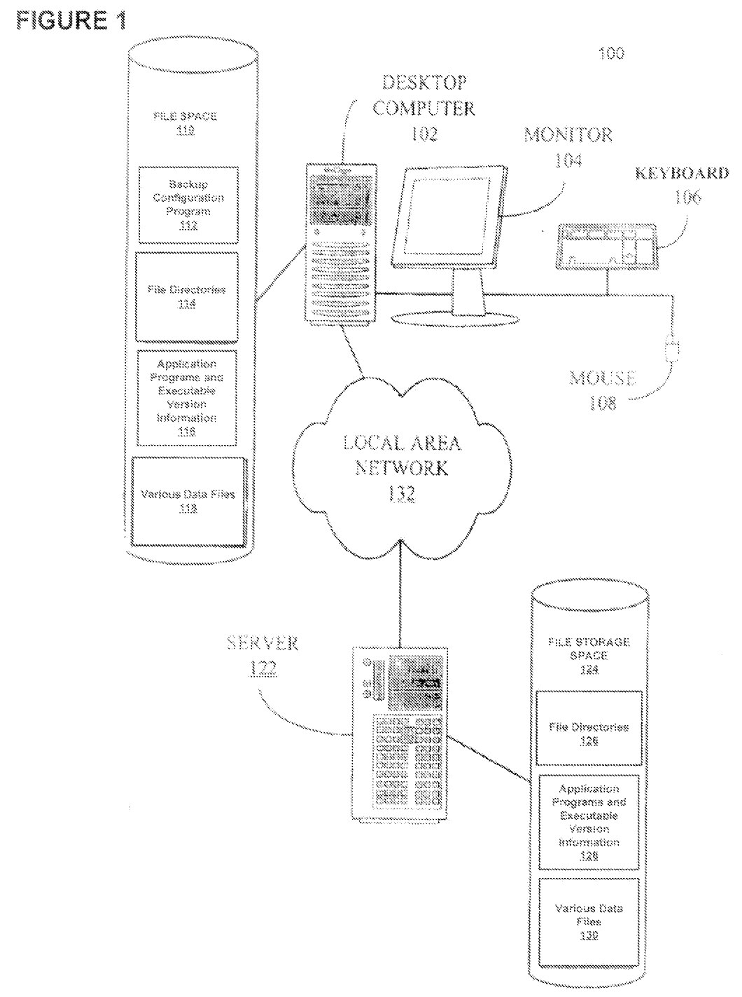

Turning now to the figures, FIG. 1 is a block diagram of exemplary computing system architecture 100. A desktop computer 102 is connected to a monitor 104, a keyboard 106 and a mouse 108, which together facilitate human interaction with computer 102. Attached to computer 102 is a file space component 110, which may either be incorporated into computer 102, such as an internal device or attached externally to computer 102 by means of various, commonly available connection devices such as but not limited to, a universal serial bus (USB) port.

In this example, file space 110 stores an exemplary backup application program 112, file directories 114, application programs and executable version information 116 and various data files 118. File directories 114, application programs and executable version information 116 and various data files 118 are used as examples in the following description. In addition, the file space and/or desktop computer may include other information included in a typical computer system, such as multiple application files, data and configuration and data files. Types of configuration files include, but are not limited to, application configuration files, operating system (OS) configuration files and various registries for the storage of information on the resources of computer 102. Backup configuration program 112 is described in more detail below in conjunction with FIGS. 1-3.

A server computer 122 is attached to a file storage space 124, which, like file space 110, may be an internal or external device. In this example, file storage space 124 stores file directories 126, application programs and executable version information 128 and various data files 130. File directories 126, application programs and executable version information 128 and various data files 130 are used as examples in the following description. As mentioned above, the file storage space and desktop computer may also include multiple directories, application files, data and configuration and data files found in a typical computer system. In the embodiment shown, the file storage space 124 is coupled to the desktop computer 102 via server 122 and a local area network (LAN) 132.

In one exemplary embodiment the backup configuration program 112 can execute on a computer 102 and be stored in file space 110. It should be understood that the embodiments described herein can be implemented in many types of computing systems and data storage structures but, for simplicity, is described herein only in terms of computer 102 and system architecture 100. The representation of the backup configuration method is a logical model. For example, components 112-118 may be stored in the same or separates files and loaded and/or executed within system 100 either as a single system or as separate processes interacting via any available inter process communication (IPC) techniques.

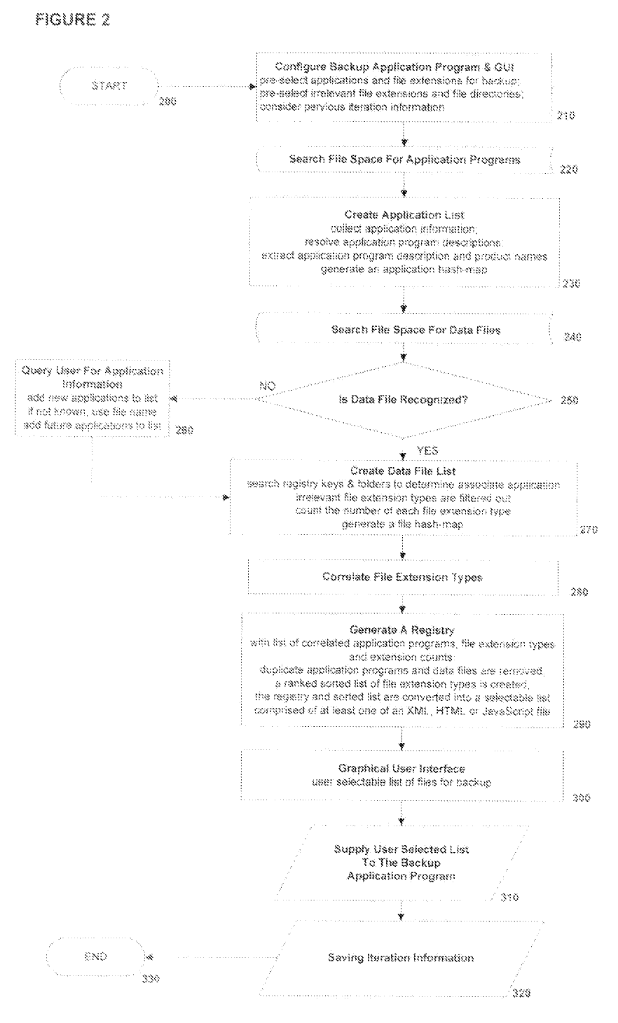

In an exemplary embodiment, the backup configuration program 118 provides for execution of a method for locating files within the file space 110, 124 of the computer system 100 (FIG. 1). In the exemplary embodiment, the backup configuration program 118 shown in FIG. 1 is described in detail in the flow chart of FIG. 2. Referring to FIG. 2, the backup configuration program is configured such that certain pre-selected directories, applications and data files having certain extensions are automatically selected for backup at step 210. In addition, certain file extensions and file directories are predetermined to be irrelevant and are therefore, excluded for backup as shown in step 210. Furthermore, the pre-selected directories, application programs, data files and file extension types for backup maybe based upon at least one of user input and iteration information stored in a cache or file storage space 124 from a previous iteration of the backup configuration application as shown in step 210.

At step 220, the backup configuration program 118 searches a list of applications programs from “KEY_CLASSES_ROOT/Applications,” in for example, a Microsoft Windows® Operating System. The backup configuration program includes a data-mining algorithm that collects open information and file extension names (i.e. “.exe”) about the applications for later lookup in step 230. Application descriptions are resolved by looking at the executable version information in step 230. The application description and product name is extracted from the executable version information in step 230. Information is collected about each application program and file extension to determine associations in step 230. Finally, in an exemplary embodiment, this information is used to generate an application hash-map based on the executable short names (e.g., winword.exe) in step 230, which links certain application file names and descriptions to certain file extensions.

Further, in the exemplary embodiment, the data-mining algorithm scans the computer user's personal space (e.g., My Documents or d:/documents on my system) and the common areas (e.g. All Users/My Documents) for files in step 240. The backup configuration program 112 attempts to recognize data files by their features (i.e. filename extensions) in step 240. If the backup configuration program 112 does not recognize a program file as shown in step 250, the user is queried for application program information at step 260. If the application description and product name cannot be determined from the executable version information, the application's file name may also be used. If the application program information is new, it is added to list of data files at step 260. At step 260, the configuration program may also query the user for information about any future applications that may be install in the file space. A count is taken of the number of each file extension type and a file hash-map is generated at step 270. Irrelevant file extension types are filtered out at step 270.

All data files are correlated to their appropriate application program based on their file extension type at step 280. Various registry keys and folders are searched to determine which applications open which files in step 280. A list of applications and associated file extensions is created at step 290 and is updated during each file scan in step 240.

Further, in the exemplary embodiment, the correlated application programs, file extension types and extensions counts are stored in a list registry in step 290. Duplicate application programs and files are removed from the registry in step 290. The method further comprises creating a ranked and sorted list of the file extension types in the registry based on a scaling factor related to the count (number) of each file extension type as shown in step 290. The method creates a sorted list of the file extension types based on a scaling factor so that file extension types occurring most frequently appear at the top of the list in step 290. Next, the method converts the registry and sorted list into at least one of an XML, HTML or JavaScript file to create a selectable list of files for backup at step 290.

The computer's graphical user interface is used to present the end user with a list of files for backup a step 300. Here, the end user is presented with a simplified process for selecting which files to backup. The list of data files is presented in order from highest priority to lowest priority based on the scaling factor. The user-selected list of files for backup is supplied to backup application program shown in step 310. Further in the exemplary embodiment, iteration information including at least one of the registry, sorted list and user selected list of files for backup is saved in a cache or memory, shown at step 320, of the computer system for future reference by the backup configuration program 112. The algorithm can store as much information as needed (e.g. the file counts, list of extensions) to help the user to make an even more informed decision the next time the backup configuration program is used.

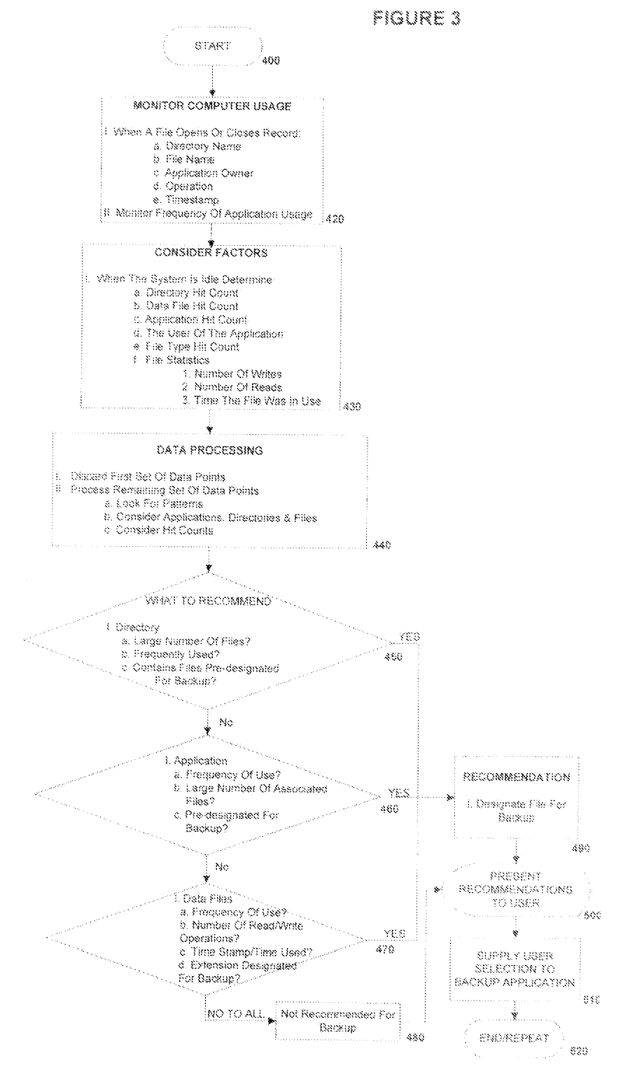

In a further exemplary embodiment, the backup configuration program 112 may be configured to automatically run periodically to detect new files and applications to designate for back up as shown in FIG. 3. The system is configured as shown in step 410, in a similar fashion as step 210 in FIG. 2. Further, as shown in FIG. 3, the backup configuration program 112 automatically monitors computer usage, shown in step 420, to determine when a file is opened or closed. When files are opened and/or closed, the backup configuration program 112 records information regarding the file name, directory where the file is stored, associated application, the application owner, the operation performed on the file and timestamp information, as shown in step 420. The backup configuration program 112 also monitors applications for frequency of usage, also shown in step 420. This data is gathered to identify patterns related to the user's use of the files stored on the computer system 100.

The backup configuration program 112 identifies patterns of usage based on a number of factors including the file directory hit count, the file hit count, the application hit count, the user of the application, the file type (extension) hit count and file statistics, as shown in step 430. File statistics may include the number of reads and/or write operations performed on the file and the length of time the file was in use, also shown in step 430. The backup configuration program executes in the background, recording this information while the computer is in use. When the computer 100 is idle, the recorded information is compiled so that the recommendations can be presented to the end user. This ensures that the statistics are not changing as the patterns are being determined. Data such as file directory hit counts, file hit counts and application hit counts, enables the backup configuration program to determine the most popular and most frequently used directories, applications and files.

In one exemplary embodiment, the pattern recognition data processing discards the first set of recorded data points, in order to remove any incomplete data, as shown in step 440. The remaining data points are processed in order to look for patterns. The frequency of use of the files, directories and applications is factored into a scaling factor so that a determination of which directories, applications and files most likely require backup protection.

The scaling factor is used to order a ranked list of files, directories and application for backup. In an exemplary embodiment, directories having a large number of files or directories having frequently accessed files may be given priority for backup protection, as shown in step 450. Other factors may also be considered when determine which file directory should be protected. Furthermore, during the backup program configuration phase, step 410, certain directories may be pre-designated for backup protection, also shown in step 410. For example, the file directory “My Documents” on the Microsoft Windows® operating system or the “iTunes®” directory on the Apple OS X® operating system may be designated for automatic backup by default. A variety of other methods for default back up of certain files may also be configured in the backup configuration program 112.

Information resolved during the data processing step 440 is also used to determine which application programs require protection. Again, in an exemplary embodiment, application programs that are frequently used or application programs that have a large number of associated files are deemed important and designated for backup, as shown in step 460. Application program that where pre-designated for backup during the configuration step 410, are also recommended for backup. Application programs may also be designated for back up for other reasons as well.

A similar process occurs when determining which files to backup. Factors considered may include a program file's frequency of use, number of read and write operations, time of usage as shown in step 470. In exemplary embodiment this information is used to determine which files to recommend for backup. Similarly, certain file extensions are pre-designated for backup during the configuration step 410. Therefore, based on a program file's extension, it may be included or excluded for backup, as shown in step 470. Other factors that may also be considered when recommending files for backup. The exemplary embodiment only considers a few.

A recommendation is made as to which directories, applications and files require backup, as shown in step 490. Files that are determined as requiring backup are rank listed and presented as recommendations to the end user as shown in step 500. Similarly, if no directories, applications and files are determined as requiring backup, as shown in step 480, this information is presented to the end user as well. After the recommendations are presented to the user, the end user may then select specific directories, applications and files for back up as shown in step 500. This information is provided to a backup application program that protects the selected files as shown at step 510. The backup configuration program may continue to execute in the background of the operating system of the computer system 100 or it may terminate as shown in step 520.

Although the exemplary embodiments described above assume there is a single user of the computer system 102 (FIG. 1), in other embodiments the application may apply to multiple users of a single computer system. Furthermore, in still another embodiment, the application may apply to one or more users on a computer network. Various embodiments included applications that are expandable to include multiple file directories across a plurality of computers and computer platforms.

As one example, exemplary embodiments described herein can be included in an article of manufacture (e.g., one or more computer program products) having, for instance, computer usable media. The media has embodied therein, for instance, computer readable program code means for providing and facilitating the capabilities of the exemplary embodiments. The article of manufacture can be included as a part of a computer system or sold separately.

Additionally, at least one program storage device readable by a machine, tangibly embodying at least one program of instructions executable by the machine to perform the capabilities of the exemplary embodiments can be provided.

The flow diagrams depicted herein are just examples. There may be many variations to these diagrams or the steps (or operations) described therein without departing from the spirit of the embodiments described herein. For instance, the steps may be performed in a differing order, or steps may be added, deleted or modified. All of these variations are considered a part of the exemplary embodiments.

While exemplary embodiments have been described, it will be understood that those skilled in the art, both now and in the future, may make various improvements and enhancements which fall within the scope of the claims which follow. These claims should be constructed to maintain the proper protection for the embodiments described herein.

1. A method for generating a list of recommended files for backup, comprising:
pre-selecting for backup certain application programs, data files and file extension types stored in a computer file space;
searching the file space to discover other application programs, data files and file extension types stored therein;
creating an application hash-map containing application programs found within the file space and their associated file extension types;
correlating data files having certain file extension types to their associated application programs based on information stored in the application hash-map;
generating a selectable list of items for backup, wherein the items include application programs, data files and file extension types, and wherein items on the list are ranked based on a scaling factor; and
presenting to a user in a graphical user interface, the selectable list of items for backup.

2. The method according to claim 1, wherein the scaling factor is determined by counting the number of files for each file extension type, wherein the most frequently occurring file extension type receive the highest priority for backup.

3. The method according to claim 1, wherein certain application programs, data files and file extension types are pre-selected for backup based upon at least one of a user input and iteration information stored in a cache from a previous iteration of the backup configuration application.

4. The method according to claim 1, wherein certain file application programs, data files and file extension types are predetermined to be irrelevant and filtered out.

5. The method according to claim 1, wherein the user selects from the list presented in the graphical user interface, certain application programs, data files and file extension types for backup, and
wherein the user selections are supplied to a process in a backup application program.

6. The method according to claim 1, wherein the step of creating the application hash-map comprises searching for information about the application programs, file extension types and executable version information in the file space to resolve an application program list, application extension list and application program descriptions.

7. The method according to claim 1, wherein at least one of the application hash-map, file hash-map and user selected list of items for backup, is saved for future use as iteration information for configuring operations of the backup configuration program.

8. A system for generating a list of recommended files for backup, the system comprising:
a computer file space containing pre-selected application programs, data files and file extension types for backup;
an apparatus for searching the computer file space to discover other application programs, data files and file extension types stored therein;
an apparatus for creating an application hash-map containing application programs found within the computer file space and their associated file extension types;
an apparatus for using the application hash-map to correlate the data files having certain file extension types to its associated application program;
an apparatus for generating a selectable list of recommended items for backup, wherein the items include application programs, data files and file extension types, and wherein items on the list are ranked based on a scaling factor;
a graphical user interface is used to present the end user with the selectable list of recommended items for backup.

9. The system according to claim 8, wherein the scaling factor is determined by counting the number of files for each file extension type, wherein the most frequently occurring file extension types receive the highest priority for backup.

10. The system according to claim 8, wherein the backup configuration program presents a user-selectable list of future applications and their associated extensions for backup that may later be installed in the file space.

11. The system according to claim 10, wherein duplicate application programs and data files are removed from the selectable list of items for backup.

12. The system according to claim 8, wherein application program descriptions and product names are extracted from the executable version information contained in the computer network file space if available, and wherein the user is queried for an application description if the executable version information is not available.

13. A method for generating a list of recommended files for backup the method, comprising:
configuring an application program to automatically search a network file space on a computer network for at least one of directories, application programs, data files and file extension types that are pre-selected for backup;
monitoring computer usage to record usage information including at least one of accessed directories, accessed application programs, accessed data files and accessed file extension types;
identifying patterns of use based on the usage information and compiling usage data;
processing the usage data in a pattern recognition process to determine at least one of directories, application programs, data files and application file extension types, having priority for backup based on a scaling factor and listing the data in a ranked list of recommended items for backup;
searching the network file space to determine at least one of other directories, application programs, data files and file extension types stored therein;
creating an application hash-map containing application programs found within the network file space and their associated file extension types;
correlating data files having certain file extension types to its associated application program based on the information stored in the application hash-map;
creating a correlated list of items for backup, wherein the items include at least one of directories, application programs, data files and application file extension types that are ranked according to a scaling factor;
generating a selectable list of ranked items for backup based on both the ranked list of recommended items for backup and the list of correlated items for backup; and
presenting to a user in a graphical user interface, the selectable list of ranked items for backup.

14. The method according to claim 13, wherein the patterns of usage are based on factors including the file hit count, the application hit count, the user of the application program, the file extension type hit count, and other file statistics.

15. The method according to claim 14, wherein file statistics may include the number of read and/or write operations performed on the file, the size of the file, the type of file, and the length of time the file was in use.

16. The method according to claim 13, wherein the backup configuration program executes in the background, recording information while the computer is in use and compiling usage data when the computer is idle.

17. The method according to claim 13, wherein the pattern recognition process discards the first set of recorded data points in order to remove any incomplete data.

18. The method according to claim 13, wherein the ranked list of recommended items for backup includes items ranked based on a scaling factor that considers the frequency of use of directories, application programs, data files, and application file extension types.

19. The method according to claim 18, wherein the scaling factor further gives priority to directories containing a large number of files, directories frequently accessed or directories pre-designated for backup.

20. The method according to claim 13, wherein application program descriptions and product names are extracted from the executable version information contained in the computer network file space if available, and wherein the user is queried for an application description if the executable version information is not available.
